(19) United States
(12) Patent Application Publication
(10) Pub. No.: US 2010/0301806 A1
(43) Pub. Date: Dec. 2, 2010

(54) RECHARGEABLE ELECTRIC HERB GRINDER

(76) Inventors: Manuel Ormaza, Miami, FL (US); Arturo Hernandez, Miami, FL (US); Armando Hernandez, Miami, FL (US)

Correspondence Address: Patent Jurist, 2225 East Bayshore Road, Suite 200, Palo Alto, CA, 94303, US

(21) Appl. No.: 12/472,372

(22) Filed: May 26, 2009

(51) Int. Cl. H02J 7/00

(52) U.S. Cl. 320/115

(57) ABSTRACT

A rechargeable electric herb grinder according to one embodiment comprises a grinder housing having one or more of housing compartments attachable to each other along a separating joint, a grinding chamber for receiving an herb, the grinding chamber being formed inside the grinder housing by the housing compartments and a spacer, an electric motor separated from the grinding chamber by the spacer, the spacer being rigidly coupled to the electric motor, a driven shaft mounted and received in the grinder chamber through an aperture in the spacer for rotation of a grinding means mounted on the driven shaft by the power provided by the electric motor, the grinding means being utilized to grind the herb, an internal rechargeable battery located outside of the grinding chamber, the internal rechargeable battery having first conductors to provide electric current to the electric motor, a recharging plug coupled to the grinding housing to recharge the internal rechargeable battery and having second conductors for connecting to an external power supply, thereby enabling recharging of the internal rechargeable battery, and a two-condition control switch, a relay having at least one pair of openable and closable contacts, and third conductors electrically interconnecting the electric motor, the two-condition control switch and the relay with the internal rechargeable battery.

### FIELD

This application relates generally to portable grinders and, more specifically, to electric herb grinders.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Traditionally, electric grinders have been powered by disposable batteries. These batteries wear out fast and need to be replaced often. An herb grinder can be powered by a disposable battery. Because such a battery cannot be recharged, it must be disposed of when exhausted. Attempting to recharge a non-rechargeable battery may cause a battery explosion.

Rechargeable batteries have been traditionally used for large consumer devices such as light vehicles (e.g., a motorized wheelchair, a golf cart, an electric bicycle, and an electric forklift), tools, and uninterruptible power supplies. Most battery chargers used with these devices can take several hours to charge a battery.

Recently, smaller rechargeable batteries have been offering economic and environmental benefits compared to disposable batteries. Rechargeable batteries help those who desire the ease of use and added efficiency that portable devices offer, but do not want to buy replacement batteries. The devices that come with smaller rechargeable batteries require a charger, which is heavy, bulky, and inconvenient to use. Furthermore, where a user is traveling abroad, even should the charger prove compatible with the local electrical power supply, a power outlet adapter will almost certainly be necessary adding to expense and further inconveniencing the user.

### SUMMARY

This summary is provided to introduce a selection of concepts in a simplified form. These concepts are further described below within the detailed description. This summary is not intended to identify key or essential features, nor is it intended to be used as an aid in determining the scope of the claimed subject matter.

In an example, an electric herb grinder can include a grinder housing having one or more of housing compartments attachable to each other along a separating joint, a grinding chamber for receiving an herb, the grinding chamber being formed inside the grinder housing by the housing compartments and a spacer, an electric motor rigidly coupled to and separated from the grinding chamber by the spacer, an internal rechargeable battery located outside of the grinding chamber, the internal rechargeable battery having first conductors to provide electric current to the electric motor, a recharging plug coupled to the grinding housing to recharge the internal rechargeable battery and having second conductors for connecting to an external power supply, thereby enabling recharging of the internal rechargeable battery, a two-condition control switch, a relay having at least one pair of openable and closable contacts, and third conductors electrically interconnecting the electric motor, the two-condition control switch and the relay with the internal rechargeable battery, and a driven shaft mounted and received in the grinder chamber through an aperture in the spacer for rotation a grinding means mounted on the driven shaft, the grinding means being utilized to grind the herb.

In an example, the electric herb grinder includes a rechargeable plug connectable to the external power supply via a Universal Serial Bus (USB). In an example, the electric herb grinder includes the external power supply, which can be portable computer providing power via a USB port and a USB cable. Alternatively, adapters for wall power outlets and car power outlets/cigarette lighters can be utilized to provide the external power for the electric herb grinder. In an example, the electric herb grinder includes the housing compartments as a top lid of the grinding housing. In an example, the electric herb grinder has the top lid and the grinding housing, which include compatible screw threads, and is attachable to each other at the separating joint by engaging the screw threads.

In an example, the electric herb grinder includes a housing compartment made of plastic or any suitable housing material such as, for example, wood, metal, glass, and clay. In an example, the electric herb grinder includes a housing compartment, which can be snapped on, thereby allowing a user to replace the internal rechargeable battery and the motor. In an example, the electric herb grinder includes a blade as the grinding means. In an example, the electric herb grinder can include a blade coupled to the shaft by a screw. In an example, the electric herb grinder includes teeth as the grinding means. In an example, the electric herb grinder includes blades as the grinding means. In an example, the electric herb grinder includes a Direct Current (DC) motor.

In an example, the electric herb grinder includes a push button switch, pressing the push button switch results in turning on the electric motor, depressing the push button switch results in stopping the electric motor. In an example, the electric herb grinder is made of plastic. In an example, the electric herb grinder has a spacer fitting rigidly on the electric motor and around the shaft holding the grinding means to the shaft. Other features, examples, and embodiments are described below. In an example, the electric herb grinder can further comprise a light-emitting component indicating the current power of the internal rechargeable battery with one or more colors according to predetermined power thresholds. In an example, the electric herb grinder further comprises a safety switch to prevent the electric motor from running when the housing compartments are not contacting each other.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating environment within which the rechargeable electric herb grinder can be operated, in accordance with an example embodiment;

FIG. 2 is a block diagram illustrating a top view of the rechargeable electric herb grinder, in accordance with an example embodiment; and

FIG. 3 is a block diagram illustrating a side view of the rechargeable electric herb grinder, in accordance with an example embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

For the purposes of this discussion, an herb grinder is a tool utilized to shred spices, tobacco, and other herbs. The herb grinder can as be utilized as a coffee grinder. In some embodiments described herein, a rechargeable electric grinder includes an internal rechargeable battery. According to these embodiments, the internal rechargeable battery can be recharged via a plug on the body of the rechargeable electric grinder. In some example embodiments, a computer can provide power for the internal rechargeable battery via a Universal Serial Bus (USB). Other sources of power can include wall and car adapters. The rechargeable battery can power a DC motor activated by turning a power switch on. For example, the DC motor can be turned on by pushing a button located on the body of the rechargeable electric grinder. When the power is turned on, the motor can spin its shaft, which, in turn, spins the attached blade that grinds the herb placed inside a compartment of the grinder.

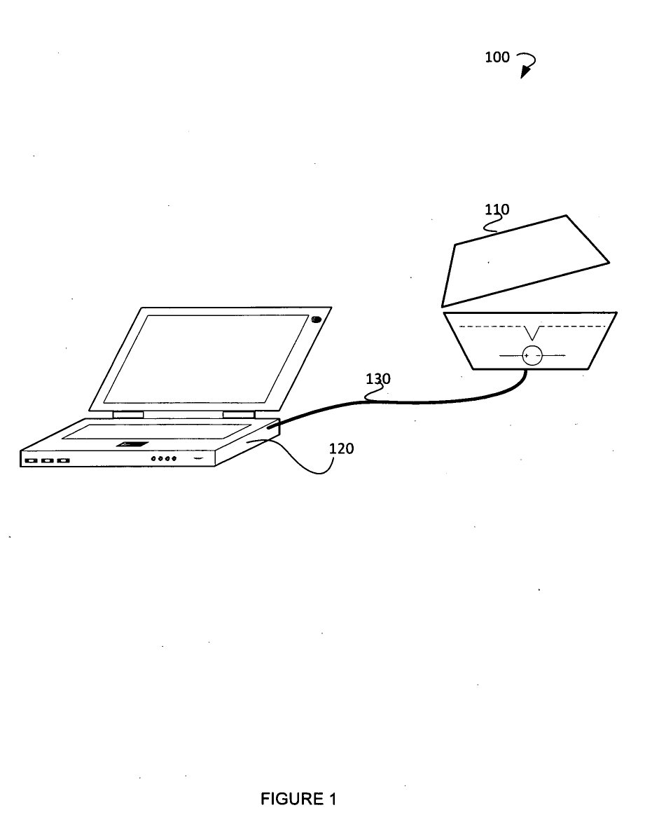

FIG. 1 illustrates an example environment 100 within which the rechargeable electric herb grinder can be operated. As shown in FIG. 1, the example environment 100 includes a rechargeable electric herb grinder 110, a portable computer 120, and a connector 130.

The portable computer 120 may be a laptop (also known as a notebook) designed for mobile use. The portable computer 120 may have most of the typical components of a desktop computer, including power one or more power source, such as a USB port. It will be understood that a desktop computer can also be used to power the rechargeable battery. The rechargeable battery, which is included in the portable computer 120, may be charged from an adapter and typically stores enough energy to run the laptop for two to three hours, depending on the configuration and power management of the computer.

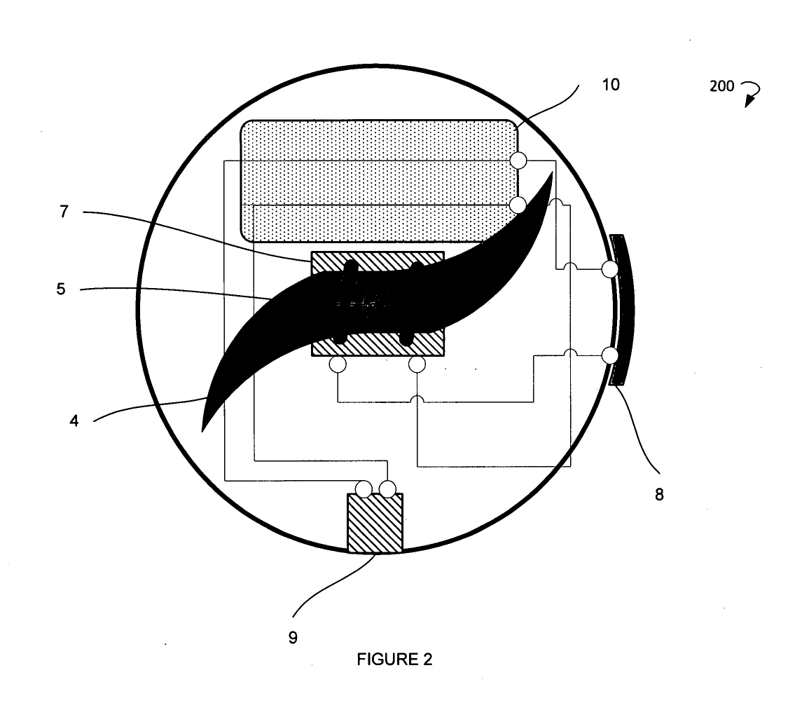

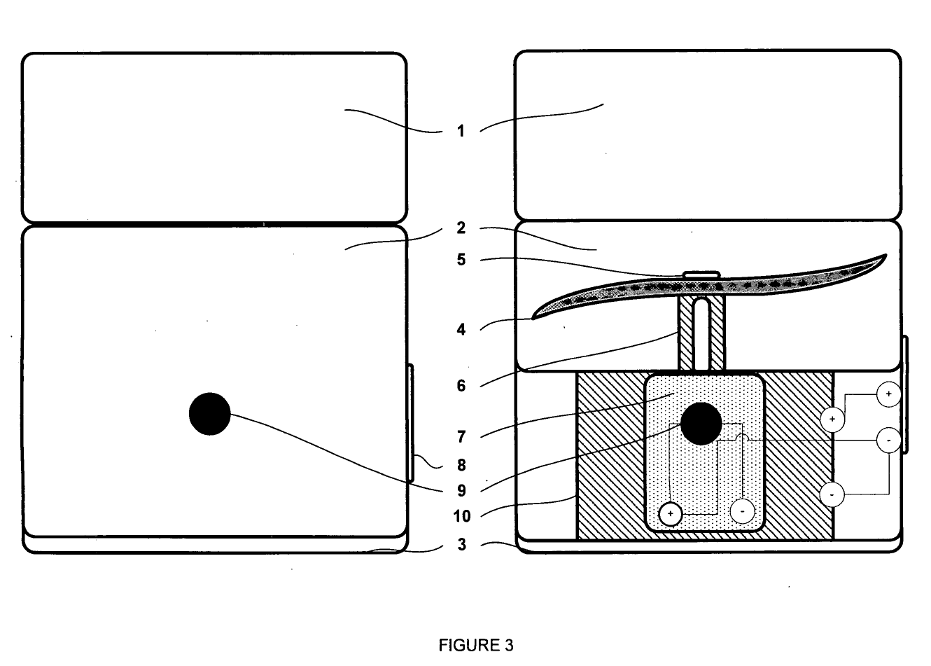

USB is a serial bus standard with the primary goal of connecting various devices to a host computer. USB was designed to allow computer peripheral devices to be connected using a single standardized interface socket and to improve plug and play capabilities by allowing hot swapping. However, the USB also includes an important functionality of providing power to low-consumption devices, eliminating the need for an external power supply. Thus, USB can provide a 5 V supply on a single wire from which connected USB devices may draw power. The specification provides for no more than 5.25 V and no less than 4.75 V (5V±5%) between the positive and negative bus power lines. It will be understood that other portable sources of power can be utilized as well. There are several types of USB connectors capable of conducting electricity from the portable computer 120 to the rechargeable electric herb grinder 110. The connector 130 is one of such USB connectors. The rechargeable electric herb grinder 110 is described in more detail with reference to FIGS. 2 and 3.

FIG. 2 illustrates the top view 200 of the rechargeable electric grinder. The top view 200 of the rechargeable electric herb grinder 110 includes a blade 4, a screw 5, a DC motor 7, a push button switch 8, a recharging plug 9, and an internal rechargeable battery 10. The blade 4 is utilized to effectively grind herbs and is attached to the shaft (described with reference to FIG. 3) of the DC motor 7 by the screw 5. The blade 7 can be of any material (e.g., metal, plastic) suitable for to shred herbs. It will be understood that the shape of the blade 7 can vary and is not limited to the shape illustrated in FIG. 2. Similarly, the screw 7 can be made of any material suitable to rigidly attach the blade 4 to the shaft of the DC motor 7.

A spacer (described with reference to FIG. 3) can separate the blade 4 from the DC motor 7. The spacer can be made of any suitable material such as, for example, plastic, wood, metal, glass, and clay. The screw 5 can be utilized to attach the blade 4 to the spacer. The spacer can also separate the grinding chamber from other internal parts of the rechargeable electric herb grinder. The DC motor 7 provides the power to spin the blade 4. The push button switch 8 switches the power ON and OFF when pressed. When pressed the push button switch 8 causes the DC motor 7 to be started. When the button switch 8 is depressed, the DC motor 7 stops. The recharging plug 9 allows recharging of the internal rechargeable battery 10 from an outside power source. In some example embodiments, the rechargeable plug 9 can accommodate the USB conductor 130. The internal rechargeable battery 10 provides the power to run the DC motor 7.

FIG. 3 is a block diagram illustrating an example side view 300 of the rechargeable electric herb grinder. The side view 30 includes a plastic screw-on top lid 1, a plastic casing 2, a plastic snap-on bottom lid 3, the blade 4, the screw 5, a plastic spacer 6, the DC motor 7, a push button switch 8, a recharging plug 9, a rechargeable battery 10, a light-emitting component 11, and a safety switch 12.

The plastic screw-on top lid 1 allows a user to place herb in the grinding chamber and screw on the plastic screw-on top lid 1 to the plastic casing 2. The plastic casing 2 holds the components within the rechargeable electric herb grinder and provides the bottom half to the grinding chamber. The plastic snap-on bottom lid 3 allows a user to change the internal rechargeable battery or the DC motor 7 when they become unusable. The blade 4 grinds herbs. The screw 5 ensures that the blade 4 is rigidly attached to the spacer 6. The spacer 6 fits tight on the DC motor 7 by slipping on around the shaft 6 of the DC motor 7 and holds the screwed on blade 4 to the motors shaft 6. The DC motor 7 provides the power to spin the blade 4 via the shaft 6. The push button switch 8, when pressed, turns on the DC motor 7. When depressed, the push button switch 8 depresses the DC motor 7. The recharging plug 9 allows recharging of the internal battery 10 from outside the casing 1. The rechargeable internal battery 10 provides the power to run the DC motor 7.

In some example embodiments, the rechargeable electric herb grinder can include a light generated, for example, by a light-emitting diode (LED). The light can indicate the current power of the internal rechargeable battery 10 by lighting up, for example, in green (when sufficient power) and in amber (when requires charging). The light can be activated when the push button switch is triggered. The light-emitting component 11 can indicate the current power of the internal rechargeable battery 10 with one or more colors according to predetermined power thresholds. The safety switch 12 can serve as a kill switch to the push button switch 8. The safety switch 12 can include conductors running from the push button switch 8, up the plastic casing 2, up and down the plastic screw-on top lid 1, back down the plastic casing 2 and back into the push button switch 8. The safety switch 12 can prevent the DC motor 7 from running unless the plastic screw-on top lid 1 is on and making contact.

Thus, in some example embodiments an electric herb grinder can comprise a grinder housing having one or more of housing compartments attachable to each other along a separating joint. The grinding herb grinder can further comprise a grinding chamber for receiving an herb, the grinding chamber being formed inside the grinder housing by the housing compartments and a spacer, and an electric motor rigidly coupled to and separated from the grinding chamber by the spacer.

The electric herb grinder can further comprise an internal rechargeable battery located outside of the grinding chamber, the internal rechargeable battery having first conductors to provide electric current to the electric motor, a recharging plug coupled to the grinding housing to recharge the internal rechargeable battery and having second conductors for connecting to an external power supply, thereby enabling recharging of the internal rechargeable battery, and two-condition control switch, a relay having at least one pair of openable and closable contacts, and third conductors electrically interconnecting the electric motor, the two-condition control switch and the relay with the internal rechargeable battery. The grinding herb grinder can further comprise a driven shaft mounted and received in the grinder chamber through an aperture in the spacer for rotation a grinding means mounted on the driven shaft, the grinding means being utilized to grind the herb.

In some example embodiments, the electric herb grinder can include a rechargeable plug, which is connected to the external power supply via a Universal Serial Bus (USB). In some example embodiments, the electric herb grinder can further comprise an external power supply, which is a portable computer providing power via a USB port and a USB cable. In some example embodiments, the electric herb grinder can include a top lid of the grinding housing, wherein the top lid and the grinding housing include compatible screw threads and are attachable to each other at the separating joint by engaging the screw threads.

In some example embodiments, the electric herb grinder can include the housing compartment made of plastic and the housing compartments can be snapped on thereby allowing a user to replace the internal rechargeable battery and the DC motor. In some example embodiments, the electric herb grinder can include a blade as the grinding means. The blade can be coupled to the shaft by a screw. The grinding means can include teeth or pegs. The electric herb grinder can include a Direct Current (DC) motor.

In some example embodiments, the electric herb grinder can include a push button switch, pressing the push button switch results in turning on the electric motor, depressing the push button switch results in stopping the electric motor. The spacer can be made of plastic. The spacer can fit rigidly on the electric motor and around the shaft holding the grinding means to the shaft. In some example embodiments, the electric herb grinder can further comprise a light-emitting component indicating the current power of the internal rechargeable battery with one or more colors according to predetermined power thresholds. In some example embodiments, the electric herb grinder further comprises a safety switch to prevent the electric motor from running when the housing compartments are not contacting each other.

Thus, a rechargeable electric herb grinder has been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. An electric herb grinder, the grinder comprising:
a grinder housing having one or more of housing compartments attachable to each other along a separating joint;
a grinding chamber for receiving an herb, the grinding chamber being formed inside the grinder housing by the housing compartments and a spacer;
an electric motor rigidly coupled to and separated from the grinding chamber by the spacer;
an internal rechargeable battery located outside of the grinding chamber, the internal rechargeable battery having first conductors to provide electric current to the electric motor;
a recharging plug coupled to the grinding housing to recharge the internal rechargeable battery and having second conductors for connecting to an external power supply, thereby enabling recharging of the internal rechargeable battery;
a two-condition control switch, a relay having at least one pair of openable and closable contacts, and third conductors electrically interconnecting the electric motor, the two-condition control switch and the relay with the internal rechargeable battery; and
a driven shaft mounted and received in the grinder chamber through an aperture in the spacer for rotation a grinding means mounted on the driven shaft, the grinding means being utilized to grind the herb.

2. The electric herb grinder of claim 1, wherein the rechargeable plug is connectable to the external power supply via a Universal Serial Bus (USB).

3. The electric herb grinder of claim 2, wherein the external power supply is a portable computer providing power via a USB port and a USB cable.

4. The electric herb grinder of claim 2, wherein one of the housing compartments is a top lid of the grinding housing.

5. The electric herb grinder of claim 1, wherein the top lid and the grinding housing include compatible screw threads and are attachable to each other at the separating joint by engaging the screw threads.

6. The electric herb grinder of claim 1, wherein the housing compartment is made of plastic.

7. The electric herb grinder of claim 1, wherein one of the housing compartments can be snapped on thereby allowing a user to replace the internal rechargeable battery.

8. The electric herb grinder of claim 1, wherein the grinding means is a blade.

9. The electric herb grinder of claim 8, wherein the blade is coupled to the shaft by a screw.

10. The electric herb grinder of claim 1, wherein the grinding means include teeth.

11. The electric herb grinder of claim 1, wherein the grinding means include pegs.

12. The electric herb grinder of claim 1, wherein the electric motor is a Direct Current (DC) motor.

13. The electric herb grinder of claim 1, wherein the two-condition control switch is a push button switch, pressing the push button switch results in turning on the electric motor, depressing the push button switch results in stopping the electric motor.

14. The electric herb grinder of claim 1, wherein the spacer is made of plastic.

15. The electric herb grinder of claim 1, wherein the spacer fits rigidly on the electric motor and around the shaft holding the grinding means to the shaft.

16. The electric herb grinder of claim 1, further comprising a light-emitting component indicating the current power of the internal rechargeable battery with one or more colors according to predetermined power thresholds.

17. The electric herb grinder of claim 1, further comprising a safety switch to prevent the electric motor from running when the housing compartments are not contacting each other.
